(19) United States
(12) Patent Application Publication
(10) Pub. No.: US 2025/0257594 A1
(43) Pub. Date: Aug. 14, 2025

(54) MOTOR VEHICLE LOCK FOR A MOTOR VEHICLE

(71) Applicant: Brose Schliesssysteme GmbH & Co. Kommanditgesellschaft, Wuppertal (DE)

(72) Inventors: Ludger Graute, Essen (DE); Frantisek Vojkuvka, Roznov (CZ); Jakub Bruzek, Jistebnik (CZ)

(21) Appl. No.: 19/051,976

(22) Filed: Feb. 12, 2025

(30) Foreign Application Priority Data
Feb. 12, 2024 (DE) 10 2024 103 830.6

(51) Int. Cl. E05B 85/26; E05B 81/14

(52) U.S. Cl. CPC E05B 85/26; E05B 81/15

(57) ABSTRACT

Lock for a vehicle, having a locking mechanism, wherein the locking mechanism has a lock latch and a pawl system, wherein the lock has an open state, a main locking state, and optionally a preliminary locking state, wherein the pawl system has a primary pawl that is pivotable between locking and open positions, and a secondary pawl that is pivotable between locking and open positions, wherein the primary pawl, in its locking position, prevents the lock latch from pivoting, in its main locking position and/or its preliminary locking position, into its open position, and wherein the secondary pawl, in its locking position, prevents the primary pawl from pivoting into its open position, wherein the motor vehicle lock has an actuating element, which, in order to transfer the lock from the main locking state and/or preliminary locking state into an open state, is able to be engaged with the pawl system.

### CLAIM OF PRIORITY

This application claims the benefit of German Patent application No. DE 10 2024 103 830.6 filed on Feb. 12, 2024, the disclosure of which is incorporated herein by reference in its entirety.

### FIELD OF THE TECHNOLOGY

Various embodiments relate to a motor vehicle lock for a motor vehicle.

### BACKGROUND

EP 3 375 961 A1 describes, for example, a motor vehicle lock which has a lock latch and a pawl system with a primary pawl and a secondary pawl. The lock latch is movable into a main locking position and a preliminary locking position. Corresponding to these two locking positions, a preliminary catch and a main catch are provided on the lock latch of the motor vehicle lock.

A drawback with the motor vehicle lock described in EP 3 375 961 A1 is that it does not always open reliably, but rather sometimes, in spite of a motor-driven opening process having been completed, sticks or falls back into a locking state.

### SUMMARY

Various embodiments address the problem of configuring and developing the known motor vehicle lock in such a way that it can be easily opened reliably.

The above problem is solved by various features described herein.

Various motor vehicle locks having a locking mechanism are known from the prior art. The motor vehicle lock in question is used in all kinds of closing elements of a motor vehicle. The closing element may be arranged on the motor vehicle so as to be pivotable and/or longitudinally movable in principle. Furthermore, it may in particular be pivotable substantially about a horizontal pivot axis or substantially about a vertical pivot axis.

Such closing elements include, for example, side doors, in particular sliding doors, tailgates, trunk lids, hoods, trunk floors or the like of a motor vehicle.

What can be essential in some embodiments is the basic consideration of providing an actuating element which, in order to transfer the motor vehicle lock from the preliminary locking state and/or main locking state into an open state, is able to be engaged with the pawl system, and wherein the pawl system has a storage element which is designed to inhibit the adoption of the main locking state and/or of the preliminary locking state.

This may be advantageous, in some embodiments, both when opening and when locking a motor vehicle lock. This is because inhibition of main catching and/or inhibition of preliminary catching makes it possible to deliberately avoid the adoption of the main locking state and/or of the preliminary locking state when this is not desired. As a result, reliable opening and/or apparent locking or reliable locking into the main catching position can be achieved.

Various embodiments provide configurations of the pawl system for inhibiting the adoption of the main locking state and/or the adoption of the preliminary locking state, which are structurally easy to produce and allow reliable opening of a closing element.

Various embodiments provide configurations of the actuating element, which allow reliable and quick opening and locking of the motor vehicle lock.

Various developments of the locking mechanism in terms of low opening forces and quiet opening are described in some embodiments.

Various developments provided in some embodiments describe structural configurations which allow the main locking state and/or the preliminary locking state to be inhibited easily and reliably.

Various embodiments describe configurations which allow the motor vehicle lock to be opened particularly easily and reliably.

Various embodiments provide a motor vehicle lock for a motor vehicle, having a locking mechanism, wherein the locking mechanism has a lock latch and a pawl system, wherein the motor vehicle lock has an open state, in which the lock latch has been pivoted into an open position, a main locking state, in which the lock latch has been pivoted into a main locking position, and optionally a preliminary locking state, in which the lock latch has been pivoted into a preliminary locking position, wherein the pawl system has a primary pawl that is pivotable between a locking position and an open position, and a secondary pawl that is pivotable between a locking position and an open position, wherein the primary pawl, in its locking position, prevents the lock latch from pivoting, in its main locking position and/or its preliminary locking position, into its open position, and wherein the secondary pawl, in its locking position, prevents the primary pawl from pivoting into its open position, wherein the motor vehicle lock has an actuating element, in particular an actuating lever, which, in order to transfer the motor vehicle lock from the main locking state and/or preliminary locking state into an open state, is able to be engaged with the pawl system, wherein the pawl system has a storage element which is designed to inhibit the adoption of the main locking state and/or the adoption of the preliminary locking state.

In various embodiments, the storage element, during the process of opening the motor vehicle lock, inhibits the adoption of the main locking state and/or preliminary locking state.

In various embodiments, the storage element, during the opening process, in order to inhibit the main locking state and/or preliminary locking state, keeps the primary pawl and/or the secondary pawl in a lifted position, and/or wherein the storage element, depending on the position of the lock latch, releases the primary pawl and/or the secondary pawl.

In various embodiments, the actuating element acts, in at least one position, in a locking direction on the pawl system, and/or wherein the actuating system, in at least one position, is supported by the pawl system.

In various embodiments, the actuating element acts in a locking direction on the pawl system while the storage element inhibits the adoption of the main locking state and/or preliminary locking state.

In various embodiments, the secondary pawl prevents the primary pawl from pivoting into its open position in the main locking state, and/or wherein the primary pawl is released by the secondary pawl in the preliminary locking state.

In various embodiments, the primary pawl is designed to be self-opening in the primary locking state, in particular is designed to be self-opening by engagement with the lock latch, and/or wherein the primary pawl is designed to be self-latching in the preliminary locking state, in particular is designed to be self-latching by engagement with the lock latch, and/or wherein the secondary pawl is designed to be self-latching in the main locking state, in particular is designed to be self-latching by engagement with the primary pawl.

In various embodiments, the storage element is formed on the primary pawl and/or on the secondary pawl, in particular by the casing thereof. In various embodiments, wherein the storage element is formed on the same arm of the primary pawl and/or secondary pawl as an actuating contour for lifting the primary pawl and/or the secondary pawl into an open position.

In various embodiments, the storage element, in order to inhibit the preliminary locking state and/or the main locking state, is supported, in particular directly, on a supporting contour of the lock latch. In various embodiments, the actuating element is supported on the primary pawl and/or secondary pawl, in particular during the inhibition of the preliminary locking state and/or of the main locking state.

In various embodiments, the supporting contour is in the form of a protrusion on and/or depression in the lock latch, and/or wherein the supporting contour is provided at the periphery of the lock latch.

In various embodiments, the supporting contour is in the form of a circular arc portion. In various embodiments, the circle center of the supporting contour in the form of a circular arc portion is located substantially on the lock latch pivot axis.

In various embodiments, the actuating element, in order to open the motor vehicle lock, is adjustable by a motor. In various embodiments, a flexible connecting element, via which the actuating element, in particular the actuating lever, is adjusted by a motor, acts on the actuating element.

In various embodiments, the motor vehicle lock has an inner actuating lever and/or an outer actuating lever for manually opening the motor vehicle lock. In various embodiments, the inner actuating lever and/or the outer actuating lever, in order to open the motor vehicle lock, acts on the actuating element.

In various embodiments, the actuating element is mounted on a bearing dome of the primary pawl and/or on a bearing dome of the secondary pawl and/or on a bearing dome of the lock latch.

In various embodiments, the actuating element first of all lifts the secondary pawl and then lifts the primary pawl, in some embodiments the actuating element, in order to transfer the motor vehicle lock into an open state, first of all engages with the secondary pawl and then engages with the primary pawl.

### DETAILED DESCRIPTION

Various aspects are explained in more detail in the following text with reference to a drawing that illustrates only exemplary embodiments. In the drawing:

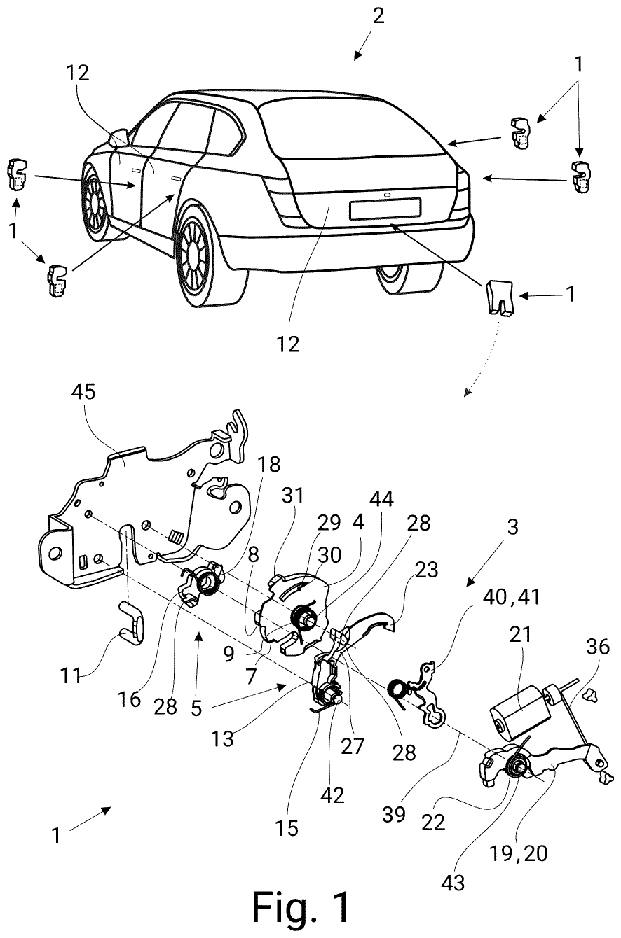

FIG. 1 shows a motor vehicle with proposed motor vehicle locks and an exploded illustration of a proposed motor vehicle lock with individual components,

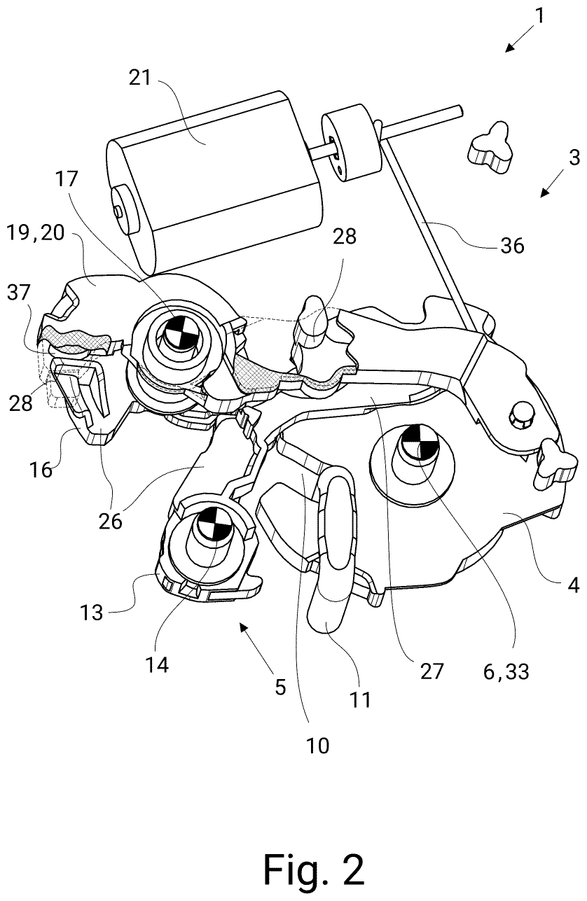

FIG. 2 shows the motor vehicle lock from FIG. 1 in the main locking state in a perspective view,

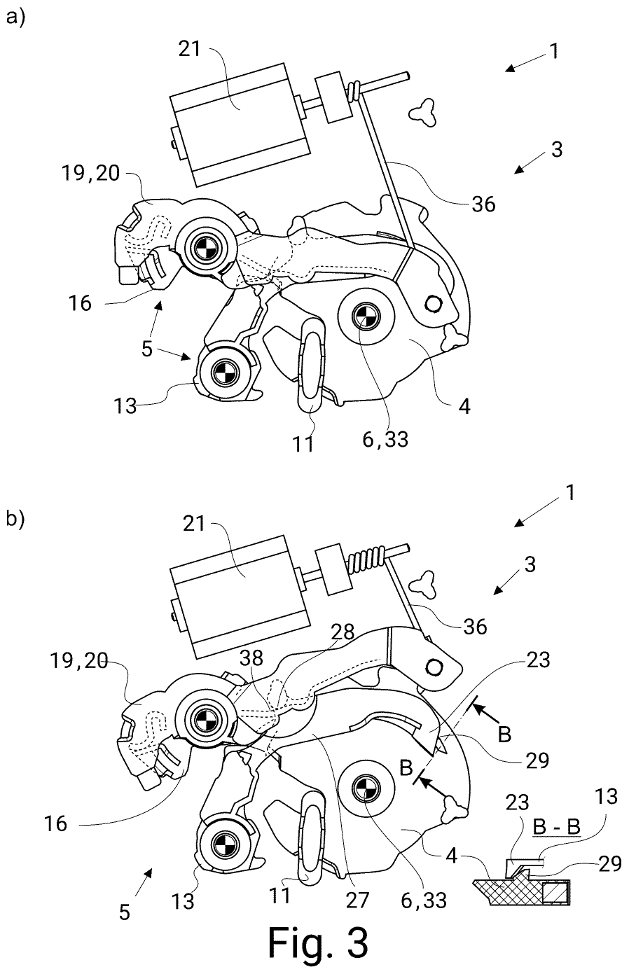

FIG. 3 shows the motor vehicle lock from FIG. 2 a) in a plan view in the main locking state and b) during a motor-driven opening process,

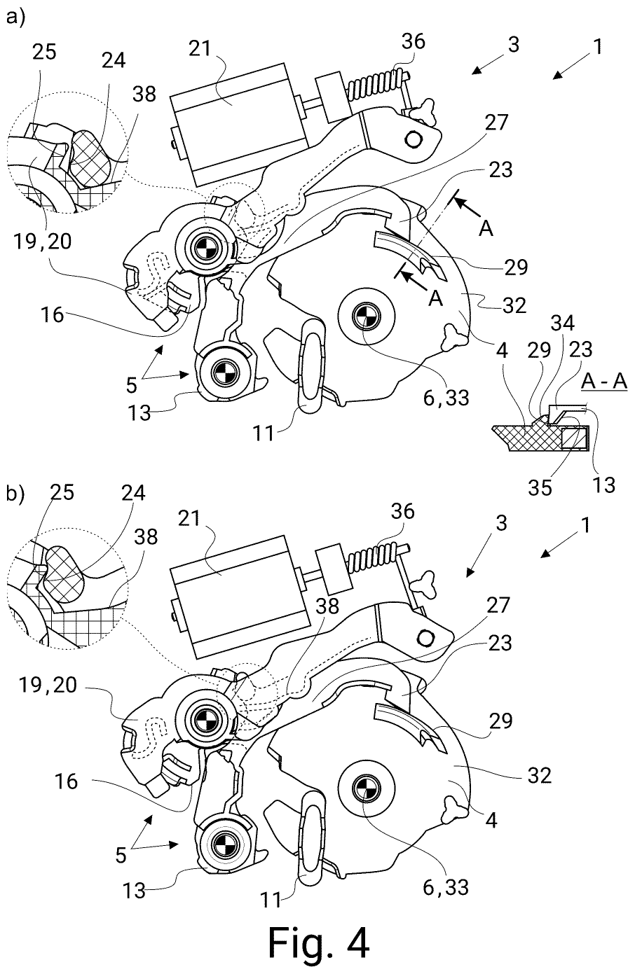

FIG. 4 shows the motor vehicle lock from FIG. 2 a) in a further course of the motor-driven opening process and b) in a likewise further course of the motor-driven opening process,

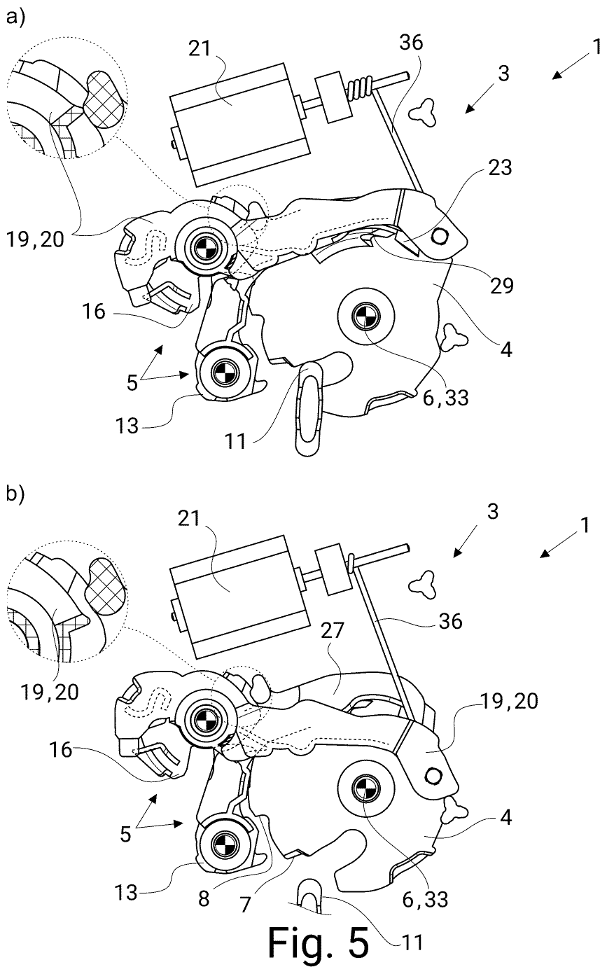

FIG. 5 shows the motor vehicle lock from FIG. 2 a) in a further course of the motor-driven opening process and b) in an open state once the opening process has been concluded, and

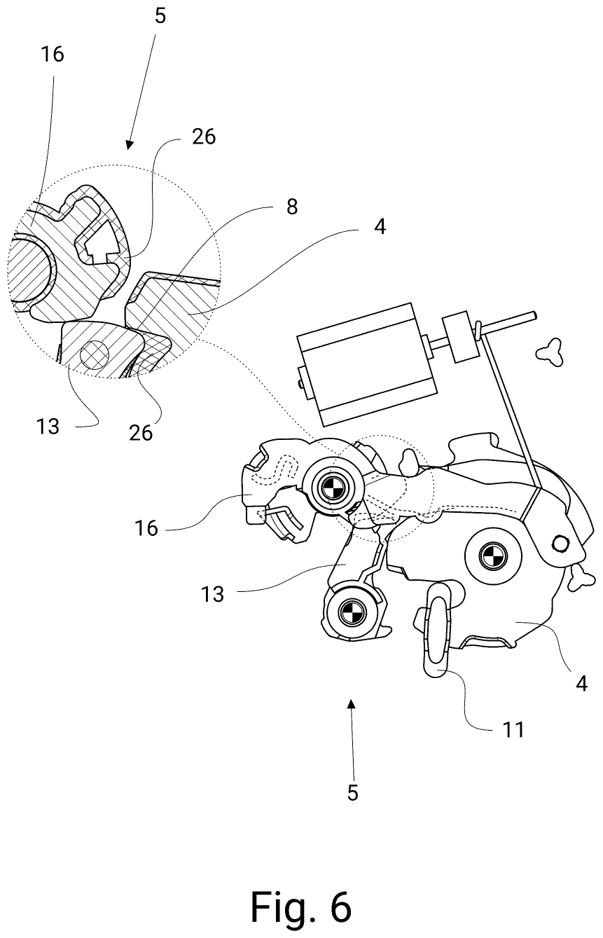

FIG. 6 shows the motor vehicle lock from FIG. 2 in the preliminary locking state.

### DETAILED DESCRIPTION

The exemplary embodiment that is illustrated in the figures relates to a motor vehicle lock 1 for a motor vehicle 2. The motor vehicle lock 1 has a locking mechanism 3. The locking mechanism 3 in turn has a lock latch 4 and a pawl system 5. The lock latch 4 is mounted pivotably about a lock latch pivot axis 6. The lock latch 4 and the pawl system 5 are shown in the figures.

Furthermore, the motor vehicle lock 1 has an open state, a main locking state and optionally a preliminary locking state. It is thus also possible for there to be no preliminary locking state. The open state is illustrated in FIG. 5b). Therein, the lock latch 4 has been pivoted into an open position. The lock latch 4 has been released by the pawl system 5.

In the main locking state, which is illustrated in FIGS. 2 and 3a), the lock latch 4 has been pivoted into a main locking position. Here, the pawl system 5 prevents the lock latch 4 from pivoting in the opening direction. To this end, in the exemplary embodiment, it engages with a main catch 7 of the lock latch 4.

In the optional preliminary locking state, the lock latch 4 has been pivoted into a preliminary locking position. Here, the pawl system 5 prevents the lock latch 4 from pivoting in the opening direction. In the preliminary locking state, the pawl system engages, in the exemplary embodiment, with a preliminary catch 8 of the lock latch 4, as shown in FIG. 6.

The lock latch 4 is spring-preloaded here and in some embodiments in the direction of its open position. To this end, a lock latch spring 9 is provided, which pushes the lock latch 4 into its open position. This is shown in FIG. 1. Furthermore, the lock latch 4 has a lock latch inlet opening 10 for receiving a locking part 11.

The lock latch 4 located in a locking position is in retaining engagement, with the motor vehicle lock 1 mounted, with a locking part 11, in particular a striker, or the like. In various embodiments, in this case, the motor vehicle lock 1 is arranged on the closure element 12 in question and the locking part 11 is arranged on the motor vehicle body. Alternatively, the motor vehicle lock 1 can be arranged on the motor vehicle body and the locking part 11 on the closing element 12 in question.

The pawl system 5 has a primary pawl 13 that is pivotable between a locking position and an open position. The primary pawl 13 is mounted pivotably about a primary pawl pivot axis 14. It is spring-preloaded here and in various embodiments in the direction of its locking position. To this end, a primary pawl spring 15 is provided, which pushes the primary pawl 15 into its locking position. This is shown in FIG. 1.

The primary pawl 13, in its locking position, prevents the lock latch 4 from pivoting, in its preliminary locking position and/or its main locking position, into its open position. In the exemplary embodiment, the primary pawl 13 can adopt a preliminary locking position, in which it blocks the lock latch 4 in its preliminary locking position, and main locking position, in which it blocks the lock latch 4 in its main locking position. The main locking position and the preliminary locking position of the lock latch 4 and of the primary pawl 13 correspond here and in various embodiments to the main locking state and preliminary locking state of the motor vehicle lock 1.

Furthermore, the pawl system 5 has a secondary pawl 16 that is pivotable between a locking position and an open position. The secondary pawl 16 is mounted pivotably about a secondary pawl pivot axis 17. It can be spring-preloaded here and in various embodiments in the direction of its locking position. To this end, a secondary pawl spring 18 is provided, which pushes the secondary pawl 15 into its locking position. This is shown in FIG. 1. The secondary pawl 16, in its locking position, prevents the primary pawl 13 from pivoting into its open position. This is the case in the main locking state in the exemplary embodiment. This is shown in FIGS. 2 and 3a).

Moreover, the motor vehicle lock 1 has an actuating element 19, in particular an actuating lever 20. The actuating element 19, or the actuating lever 20, in order to transfer the motor vehicle lock 1 from the preliminary locking state and/or main locking state into an open state, is able to be engaged with the pawl system 5. As described below, it can be actuated manually and/or by a motor and then, during its actuation, engages with the pawl system 5.

The actuating element 19 can be movable in various embodiments between a starting position and a lifted position. Furthermore, a supporting position can be provided. The actuating element 19 can be formed in various embodiments as an actuating lever 20, which is mounted pivotably about an actuating lever axis. The actuating element 19 is spring-preloaded counter to the lifting direction. To this end, an actuating element spring 22 is provided, which is shown in FIG. 1.

Moreover, in the proposed motor vehicle lock 1, a storage element 23 is provided. The pawl system 5, in particular the primary pawl 13 and/or the second pawl 16, has the storage element 23. It is designed to inhibit the adoption of the main locking state and/or of the preliminary locking state.

This may be advantageous, in some embodiments, both when opening and when locking a motor vehicle lock 1. This is because inhibition of main catching and/or inhibition of preliminary catching makes it possible to deliberately avoid the adoption of the main locking state and/or of the preliminary locking state. This is of particular significance in particular for tailgates or trunk lids. If an external load acts on a closing element 12, in particular a tailgate and/or a trunk lid, while the latter is being opened, this can result, in particular after motor-driven lifting, in direct latching again, and so the closing element 12 cannot then be opened. It is specifically this that can be avoided by the inhibition of main catching and/or inhibition of preliminary catching.

In various configurations, the inhibition of the adoption of the main locking state and/or of the preliminary locking state is configured such that, during this inhibition, the position of the primary pawl 13 is not influenced by tolerances of the actuating element 19 and/or of the secondary pawl 16.

Provision can be made in various embodiments for the storage element 23, during the process of opening the motor vehicle lock 1, to inhibit the adoption of the main locking state and/or the adoption of the preliminary locking state, such that a closing element 12 that is able to be locked with the motor vehicle lock 1 can be reliably opened.

Furthermore, in various embodiments, provision is made for the storage element 23, during the opening process, in order to inhibit the preliminary locking state and/or main locking state, to keep the primary pawl 13 and/or the secondary pawl 16 in a lifted position. In the exemplary embodiment, the storage element 23 keeps the primary pawl 13 in a lifted position, as is shown in FIG. 4b). In various embodiments, the storage element 23, which is formed here and in particular integrally with the primary pawl 13, is supported on the lock latch 4. Via the primary pawl 13, the secondary pawl 16 is also kept in a lifted position. In various embodiments, the primary pawl 13 has the storage element 23. This allows a particularly short tolerance chain for realizing the inhibition of the adoption of the main locking state and/or of the preliminary locking state. In addition, the formation of the storage element 23 on the primary pawl 13 can bring about an improved dynamic behavior of the motor vehicle lock 1, in particular in the main locking state. Here, in the exemplary embodiment and in various embodiments, the primary pawl 13 is blocked in any case by the secondary pawl 16 such that dynamic loads acting on the primary pawl 13 have no influence on the reliable locking of the motor vehicle lock 1 in the main locking state.

Additionally or alternatively, provision may also be made, however, for the secondary pawl 13 to have the storage element 23. The storage element 23, formed in various embodiments integrally with the secondary pawl 16, is the supported on the lock latch 4. In such an alternative configuration, the primary pawl 13 can be kept in a lifted position via the secondary pawl 16.

In the exemplary embodiment and in various embodiments, provision is made for the storage element 23, depending on the position of the lock latch 4, to release the primary pawl 13 and/or the secondary pawl 16. This takes place here and in various embodiments together with adjustment of the lock latch 4 into its open position. In various embodiments, in such a position of the lock latch 4 in which the locking part 11 is and/or has been released by the lock latch 4. This is shown in FIG. 5.

As a result of the above structural design, the inhibition of the preliminary locking state and/or main locking state can be provided particularly reliably and easily, and lifting thereof when the motor vehicle lock 1 is being transferred into the open state can also be realized particularly easily and reliably.

In various configurations, provision is made for the actuating element 19 to act, in at least one position, in a locking direction on the pawl system 5, and/or for the actuating system 19, in at least one position, to be supported by the pawl system 5.

The acting of the actuating lever 20 on the pawl system 5, in particular on the primary pawl 13 and/or secondary pawl 16, brings about an, in particular increased, restoring force on the pawl system 5. This has the advantage, in some embodiments, in particular when this acts only in individual positions and/or on only a part of the adjustment path, that it acts only when it is advantageous.

The supporting of the actuating element 19 by the pawl system 5 in a position, in particular during restoration from a lifted position into a starting position, can bring about quicker opening of the motor vehicle lock 1 in particular when an opening process that has previously taken place was not successful. The actuating element 19 does not then have to be adjusted along the entire path from a starting position into a lifted position again, but rather can be adjusted from a supporting position, in particular again, into the lifted position. FIG. 4b) shows the actuating element 19 as is supported by the pawl system 5, in this case the primary pawl. Here, the actuating element 19 is supported, in a supporting position, on the actuating element supporting contour 25 by a pawl supporting contour 24. The pawl supporting contour 24 is formed on the primary pawl 13 and/or on the secondary pawl 16, in particular by the casing 26 thereof, while the actuating element supporting contour 25 can be formed on the actuating element 19.

In FIG. 4a), the actuating element 19 is shown, by comparison, in the lifted position.

The actuating element 19 acts here and, in various embodiments, in a locking direction, in particular directly, on the primary pawl 13 and/or the secondary pawl 16. In the exemplary embodiment, the actuating element 19 acts only on the primary pawl 13.

Furthermore, provision is made here and, in various embodiments, for the actuating element 19 to acts in a locking direction on the pawl system 5 while the storage element 23 inhibits the adoption of the preliminary locking state and/or main locking state. As a result, the force to which the pawl system 5 is subjected in the locking direction is increased.

Furthermore, provision is made here and, in various embodiments, for the actuating element 19 to act in the locking direction, in particular directly, on the primary pawl 13 and/or the secondary pawl 16. This is shown in FIG. 4b). In the enlarged illustration in the round frame, the action of the actuating element 19 on the primary pawl 13 is shown. The primary pawl 13 is in a storage position here.

Furthermore, provision is made here, and in various embodiments, for the actuating element 19, depending on the position of the primary pawl 13 and/or depending on the position of the secondary pawl 16, to stop acting in the closing direction on the primary pawl 13 and/or the secondary pawl 16.

Furthermore, provision is made here and, in various embodiments, for the actuating element 19, during the opening process, to act in the locking direction on the primary pawl 13 and/or the secondary pawl 16 until the lock latch 4 has been adjusted beyond its preliminary locking position in the opening direction. Additionally or alternatively, provision may be made for the actuating element 19, during the opening process, to stop acting in the locking direction on the primary pawl 13 and/or the secondary pawl 16 before the lock latch 4 has moved into the open position. As a result, reliable locking of the motor vehicle lock 1 after it has been opened can be ensured.

Furthermore, provision is made in the exemplary embodiment and, in various embodiments, for the primary pawl 13 to have engaged with a main catch 7 of the lock latch 4 in the main locking state. The secondary pawl 16 prevents the primary pawl 13 from pivoting into its open position. This is shown in FIG. 3a). In the preliminary locking state, provision is made in the exemplary embodiment and, in various embodiments, for the primary pawl to have engaged with a preliminary catch 8 of the lock latch 4. The primary pawl 13 has in this case can have been released by the secondary pawl 16. In the preliminary locking state shown in FIG. 6, the secondary pawl 16 and the primary pawl 13 are here and, in various embodiments, not engaged with one another in a blocking manner.

Furthermore, the locking mechanism 3 of the motor vehicle 1 lock is designed here and, in various embodiments, such that the primary pawl 13 is designed to be self-opening in the primary locking state, in particular is designed to be self-opening by engagement with the lock latch 4. This means that the lock latch 4, in its locking position, can push the primary pawl 13 that is engaged with it out of joint engagement by way of a force that it exerts. In order to keep the lock latch 4 in the main locking position, the secondary pawl 16 is required here. In the main locking state, the secondary pawl 16 prevents, in its locking position, the primary pawl 13 from pivoting into its open position.

Additionally or alternatively, provision is made here for the primary pawl 13 to be designed to be self-latching in the preliminary locking state, in particular to be designed to be self-latching by engagement with the lock latch 4. This means here that, in the preliminary locking state, the lock latch 4 cannot push the primary pawl 13 out of joint engagement by way of a force that it exerts. The primary pawl 13 is self-latching. The secondary pawl 16 is not required in the preliminary locking state here.

Furthermore, provision can additionally or alternatively be made for the secondary pawl 16 to be designed to be self-latching in the main locking state, in particular to be designed to be self-latching by engagement with the primary pawl 13. This means here that, in the preliminary locking state, the primary pawl 13 cannot push the secondary pawl 16 out of joint engagement by way of a force that it exerts. The secondary pawl 16 is self-latching.

Furthermore, provision is made here and, in various embodiments, for the storage element 23 to be formed on the primary pawl 13 and/or on the secondary pawl 16, in particular by the casing 26 thereof. In the exemplary embodiment, the storage element 23 is formed by the casing 26 thereof.

In various embodiments and in the exemplary embodiment, the storage element 23 is formed on the same arm 27 of the primary pawl 13 and/or secondary pawl 16 as an actuating contour 28 for lifting the primary pawl 13 and/or the secondary pawl 16 into an open position. Here, the actuating contour 28 is also formed by the casing 26 of the primary pawl 13.

Here, the secondary pawl 16 also has an actuating contour 28 for lifting into an open position. This is formed here by a casing 26 of the secondary pawl 16.

In various embodiments, the storage element 23 and/or the actuating contour 28 is formed by a casing 26. It is made here from a plastic. In particular, the encapsulation of a metal pawl core with a plastic in order to produce a casing 26 has proven successful. This is the case here and, in various embodiments, both for the primary pawl 13 and for the secondary pawl 16.

Alternatively, provision may also be made, however, for the storage element 23 to be fastened to the primary pawl 13 and/or secondary pawl 16 by a force-fitting and/or form-fitting connection, in particular a snap-fitting connection. The storage element 23 can then be made, for example, of plastic and/or a metal sheet.

Furthermore, provision is made here and, in various embodiments, for the storage element 23, in order to inhibit the preliminary locking state and/or the main locking state, to be supported, in particular directly, on a supporting contour 29 of the lock latch 4. This is shown in FIG. 4. The actuating element 19 is supported here on the primary pawl 13, in particular during the inhibition of the preliminary locking state and/or main locking state. During the inhibition, the storage element 23 in this case prevents the primary pawl 13 and/or the secondary pawl 16 from engaging.

Here and in various embodiments, the supporting contour 29 is, as shown in the sectional illustrations in FIGS. 3b) and 4a), inclined with respect to the lock latch pivot axis 6, between 0° and 10°, or between 4° and 6°. Here and in various embodiments, an imaginary extension of the supporting contour 29 and the lock latch pivot axis 6 intersect on the side of the lock latch 4 facing away from the supporting contour.

The inhibition of the preliminary locking state and/or of the main locking state is stopped here and in various embodiments by a pivoting movement of the lock latch 4 in the direction of its open position, here and in various embodiments after it has been overtwisted in the opening direction beyond its preliminary locking position. Here and in various embodiments, the storage element 23 leaves its storage position to this end. In the exemplary embodiment and in various embodiments, the storage element 23 extends along the supporting contour 29 and is released by the latter. This is shown in FIGS. 4 and 5. The supporting contour 29 is pivoted away from the storage element 23 here and in various embodiments by a pivoting movement of the lock latch 4 to release the latter.

Furthermore, provision is made here and in various embodiments for the supporting contour 29 to be in the form of a protrusion 30 on and/or depression in the lock latch 4, and/or for the supporting contour 29 to be provided at the lock latch periphery 31. In the exemplary embodiment, the supporting contour 29 is in the form of a protrusion 30 from a surface, in particular orthogonal to the lock latch pivot axis 6, of the lock latch 4. It is provided here at an offset to the preliminary catch 8 and/or the main catch 7 of the lock latch 4 in a direction along the lock latch pivot axis 6. In various embodiments, the supporting contour 29 is formed by a lock latch casing 32. It is made here from a plastic. In particular, the encapsulation of a metal lock latch core with a plastic has proven successful in order to produce the lock latch casing 32.

Furthermore provision is made here and in various embodiments for the supporting contour 29 to be in the form of a circular arc portion, as is shown for example in FIG. 4.

The circle center 33 of the supporting contour 29 in the form of a circular arc portion is located substantially on the lock latch pivot axis 6 here. When the lock latch 4 is pivoted into an open position, this ensures, here and in various embodiments, that the storage element 23 slides particularly well along the supporting contour 29.

The inhibition of the preliminary locking state and/or of the main locking state takes place, as described, by means of the storage element 23. The adoption of a storage position of the storage element 23 in order to inhibit the preliminary locking state and/or the main locking state can be seen in the sectional illustration B-B in FIG. 3b) and the sectional illustration A-A in FIG. 4b. In order to adopt the storage position, shown in FIG. 4, of the storage element 23, the storage element 23 here and in various embodiments rebounds and/or lifts. Here, the primary pawl 13 is kept in its storage position by the storage element 23. In the exemplary embodiment and in various embodiments, the storage element 23 runs along a storage element lifting contour 34 and/or latches together with the supporting contour 29. The spring action is, to this end, provided in particular by the arm 27. For lifting, the storage element 23 has a running contour 35. This runs here and in various embodiments in order to lift the storage element 23, along the storage element lifting contour 34 and the storage element 23 is lifted in the process. When latching with the supporting contour 29 occurs, the inhibition of the preliminary locking state and/or the main locking state is active.

Furthermore, provision is made here and in various embodiments for the actuating element 19, in order to open the motor vehicle lock 1, to be adjustable by a motor. By means of a motor 21, the actuating element 19 can, for opening purposes, be adjusted from a starting position into a lifted position. In the exemplary embodiment, a flexible connecting element 36, via which the actuating element 19, in particular the actuating lever 20, is adjusted by the motor 21, acts on the actuating element 19. The motor 21 is an electric motor here. It is driven here and in various embodiments unidirectionally. Here, in order to open the motor vehicle lock 1, the actuating element 19 is acted upon by the motor 21 and in various embodiments first of all the secondary pawl 16 and then the primary pawl 13 is lifted. In the exemplary embodiment and in various embodiments, the actuating element 19, to this end, acts first upon an actuating contour 28 of the secondary pawl 16 and then upon an actuating contour 28 of the primary pawl 13. Here and in various embodiments, the actuating element 19, in order to act upon the actuating contour 28 of the secondary pawl 16, has an, in particular first, lifting contour 37 and, in order to act upon the actuating contour 28 of the primary pawl 13, has an, in particular second, lifting contour 38. Here and in various embodiments, the first lifting contour 37 and the second lifting contour 38 are arranged on opposite sides of the actuating element pivot axis 39. This is shown in FIGS. 2 and 3. The further opening process is illustrated in FIGS. 4 and 5.

On opening the motor vehicle lock and actuating the actuating element, the actuating contour 28 of the primary pawl 13 here and in various embodiments travels along the lifting contour 38. The lifting contour has here and in various embodiments a plurality of different contour portions. Here and in various embodiments, at least two and/or three contour portions are provided, which have different geometric shapes. This traveling is shown in FIGS. 3 and 4.

In various embodiments, a first, in particular circular contour portion has a different curvature, in particular a different curvature direction, than a second, in particular circular contour portion. Additionally or alternatively, a straight contour portion can be provided. Here and in various embodiments, the contour portions along which the actuating contour 28 travels are arranged without interruption alongside one another. On opening the motor vehicle lock, the actuating contour 28 engages first of all with a contour portion of the lifting contour 28, the curvature of which is directed away from the actuating contour. Then, the actuating contour travels here and in various embodiments along the contour portion and as far as the second contour portion. The curvature is directed here and in various embodiments toward the actuating contour. Then, the actuating contour travels here and in various embodiments along the second contour portion and as far as the third contour portion. This is formed here and in various embodiments in a straight manner. This traveling is shown in the sequence of FIGS. 3 and 4. The curvatures are in the form of radii in the exemplary embodiment.

The restoration of the actuating element 19 takes place here and in various embodiments by way of the actuating element spring 22. The latter preloads the actuating element 19 in the direction of its starting position. The actuating element spring 22 restores the actuating element 19, after the motor vehicle lock 1 has been opened, in particular from a lifted position of the actuating element 19 and/or from a storage position of the actuating element 19, into a starting position.

Furthermore, provision is made here and in various embodiments for the motor vehicle lock 1 to have an inner actuating lever and/or an outer actuating lever 40 for manually opening the motor vehicle lock 1, in various embodiments for the inner actuating lever 41 and/or the outer actuating lever 40, in order to open the motor vehicle lock 1, to act on the actuating element 19. This allows manual opening.

The inner actuating lever and/or an outer actuating lever 40 is mounted on a bearing dome 42 of the primary pawl and/or on a bearing dome 43 of the secondary pawl and/or on a bearing dome 44 of the lock latch. In the exemplary embodiment and in various embodiments, the inner actuating lever and/or an outer actuating lever 40 is mounted on the same bearing dome as the actuating element 19.

Furthermore, provision may be made for the actuating element 19 to be mounted on a bearing dome 42 of the primary pawl and/or on a bearing dome 43 of the secondary pawl and/or on a bearing dome 44 of the lock latch. Dual use of bearing domes allows a particularly simple and cost-effective design.

As shown in FIG. 1, here and in various embodiments, the bearing dome 42 of the primary pawl and/or the bearing dome 43 of the secondary pawl and/or the bearing dome 44 of the lock latch are fastened to a rear plate 45 of the motor vehicle lock 1. As a result, the motor vehicle lock 1 can be formed in a very particularly rigid manner.

In various embodiments, the rear plate 45 can have a rear plate inlet opening for the locking part 11. In order to further increase the rigidity, a further reinforcing plate (not shown here) can be provided, to which the bearing domes are likewise rigidly connected. In various embodiments, this can be arranged, with respect to the locking mechanism 3, on the opposite side of the motor vehicle lock 1 from the rear plate 45.

Furthermore, provision is made here and in various embodiments for the actuating element 19 first of all to lift the secondary pawl 16 and then to lift the primary pawl 13, in various embodiments for the actuating element 19, in order to transfer the motor vehicle lock 1 into an open state, to first of all engage with the secondary pawl 16 and then to engage with the primary pawl 13.

Finally, furthermore, according to a teaching that has independent meaning, a motor vehicle lock is disclosed, wherein the motor vehicle lock is for a motor vehicle 2, wherein the motor vehicle lock has a locking mechanism 3, wherein the locking mechanism 3 has a lock latch 4 and a pawl system 5, wherein the motor vehicle lock 1 has an open state, in which the lock latch 4 has been pivoted into an open position, and a main locking state, in which the lock latch 4 has been pivoted into a main locking position, and optionally a preliminary locking state, in which the lock latch 4 has been pivoted into a preliminary locking position, wherein the pawl system 5 has a primary pawl 13 that is pivotable between a locking position and an open position and optionally a secondary pawl 16 that is pivotable between a locking position and an open position, wherein the primary pawl 13, in its locking position, prevents the lock latch 4, in its main locking position and/or its preliminary locking position, from pivoting into its open position, and wherein the optionally provided secondary pawl 16, in its locking position, prevents the primary pawl 13 from pivoting into its open position, wherein the motor vehicle lock 1 has an actuating element 19, in particular an actuating lever 20, which, in order to transfer the motor vehicle lock 1 from the main locking state and/or preliminary locking state into an open state, is able to be engaged with the pawl system 5, wherein the pawl system (5), in particular the primary pawl and/or the secondary pawl, has an actuating contour 28, wherein the actuating element, in order to open the motor vehicle lock, has a lifting contour 38, wherein, on opening the motor vehicle lock and actuating the actuating element, the actuating contour 28 of the primary pawl 13 travels along the lifting contour 38 via at least two different contour portions.

This allows the lifting forces to be set particularly easily and advantageously.

Reference should be made to all the information provided about the above-described motor vehicle lock. This applies in particular to the configurations of the lifting contour 38 and the cooperation thereof with the actuating contour 28 described herein.

### LIST OF REFERENCE SIGNS

1 Motor vehicle lock
2 Motor vehicle
3 Locking mechanism
4 Lock latch
5 Pawl system
6 Lock latch pivot axis
7 Main catch
8 Preliminary catch
9 Lock latch spring
10 Lock latch inlet opening
11 Locking part
12 Closing element
13 Primary pawl
14 Primary pawl pivot axis
15 Primary pawl spring
16 Secondary pawl
17 Secondary pawl pivot axis
18 Secondary pawl spring
19 Actuating element
20 Actuating lever
21 Motor
22 Actuating element spring
23 Storage element
24 Pawl supporting contour
25 Actuating element supporting contour
26 Casing
27 Arm
28 Actuating contour
29 Supporting contour
30 Protrusion
31 Lock latch periphery
32 Lock latch casing
33 Circle center
34 Storage element lifting contour
35 Running contour
36 Connecting element
37 First lifting contour
38 Second lifting contour
39 Actuating element pivot axis
40 Outer actuating lever
41 Inner actuating lever
42 Bearing dome of the primary pawl
43 Bearing dome of the secondary pawl
44 Bearing dome of the lock latch
45 Rear plate

1. A motor vehicle lock for a motor vehicle, having a locking mechanism, wherein the locking mechanism has a lock latch and a pawl system,
wherein the motor vehicle lock has an open state, in which the lock latch has been pivoted into an open position, a main locking state, in which the lock latch has been pivoted into a main locking position, and optionally a preliminary locking state, in which the lock latch has been pivoted into a preliminary locking position,
wherein the pawl system has a primary pawl that is pivotable between a locking position and an open position, and a secondary pawl that is pivotable between a locking position and an open position,
wherein the primary pawl, in its locking position, prevents the lock latch from pivoting, in its main locking position and/or its preliminary locking position, into its open position, and
wherein the secondary pawl, in its locking position, prevents the primary pawl from pivoting into its open position,
wherein the motor vehicle lock has an actuating element, which, in order to transfer the motor vehicle lock from the main locking state and/or preliminary locking state into an open state, is able to be engaged with the pawl system,
wherein the pawl system has a storage element which is designed to inhibit the adoption of the main locking state and/or the adoption of the preliminary locking state.

2. The motor vehicle lock as claimed in claim 1, wherein the storage element, during the process of opening the motor vehicle lock, inhibits the adoption of the main locking state and/or preliminary locking state.

3. The motor vehicle lock as claimed in claim 1, wherein the storage element, during the opening process, in order to inhibit the main locking state and/or preliminary locking state, keeps the primary pawl and/or the secondary pawl in a lifted position, and/or wherein the storage element, depending on the position of the lock latch, releases the primary pawl and/or the secondary pawl.

4. The motor vehicle lock as claimed in claim 1,
wherein the actuating element acts, in at least one position, in a locking direction on the pawl system, and/or wherein the actuating system, in at least one position, is supported by the pawl system.

5. The motor vehicle lock as claimed in claim 1,
wherein the actuating element acts in a locking direction on the pawl system while the storage element-inhibits the adoption of the main locking state and/or preliminary locking state.

6. The motor vehicle lock as claimed in claim 1,
wherein the secondary pawl prevents the primary pawl from pivoting into its open position in the main locking state, and/or wherein the primary pawl is released by the secondary pawl in the preliminary locking state.

7. The motor vehicle lock as claimed in claim 1,
wherein the primary pawl is designed to be self-opening in the primary locking state,
and/or
wherein the primary pawl is designed to be self-latching in the preliminary locking state
and/or
wherein the secondary pawl is designed to be self-latching in the main locking state.

8. The motor vehicle lock as claimed in claim 1,
wherein the storage element is formed on the primary pawl and/or on the secondary pawl.

9. The motor vehicle lock as claimed in claim 1,
wherein the storage element, in order to inhibit the preliminary locking state and/or the main locking state, is supported, in particular directly, on a supporting contour of the lock latch.

10. The motor vehicle lock as claimed in claim 1,
wherein the supporting contour is in the form of a protrusion on and/or depression in the lock latch, and/or wherein the supporting contour is provided at the periphery of the lock latch.

11. The motor vehicle lock as claimed in claim 1,
wherein the supporting contour is in the form of a circular arc portion.

12. The motor vehicle lock as claimed in claim 1,
wherein the actuating element, in order to open the motor vehicle lock, is adjustable by a motor.

13. The motor vehicle lock as claimed in claim 1,
wherein the motor vehicle lock has an inner actuating lever and/or an outer actuating lever for manually opening the motor vehicle lock.

14. The motor vehicle lock as claimed in claim 1,
wherein the actuating element is mounted on a bearing dome of the primary pawl and/or on a bearing dome of the secondary pawl and/or on a bearing dome of the lock latch.

15. The motor vehicle lock as claimed in claim 1,
wherein the actuating element first of all lifts the secondary pawl and then lifts the primary pawl.

16. The motor vehicle lock as claimed in claim 8, wherein the storage element is formed on the same arm of the primary pawl and/or secondary pawl as an actuating contour for lifting the primary pawl and/or the secondary pawl into an open position.

17. The motor vehicle lock as claimed in claim 9, wherein the actuating element is supported on the primary pawl and/or secondary pawl.

18. The motor vehicle lock as claimed in claim 11, wherein the circle center of the supporting contour in the form of a circular arc portion is located substantially on the lock latch pivot axis.

19. The motor vehicle lock as claimed in claim 12, wherein a flexible connecting element, via which the actuating element is adjusted by a motor, acts on the actuating element.

20. The motor vehicle lock as claimed in claim 13, wherein the inner actuating lever and/or the outer actuating lever, in order to open the motor vehicle lock, acts on the actuating element.
